(19) United States
(12) Patent Application Publication
(10) Pub. No.: US 2010/0087303 A1
(43) Pub. Date: Apr. 8, 2010

(54) PAPERBOARD WINDING CORE FOR INORGANIC MATERIALS, HAVING REMOVABLE OUTER PLY

(76) Inventor: Jari Pietikainen, Kotka (FI)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/565,437

(22) Filed: Sep. 23, 2009

Related U.S. Application Data
(60) Provisional application No. 61/102,051, filed on Oct. 2, 2008.

(51) Int. Cl. F16C 13/00

(52) U.S. Cl. 492/53

(57) ABSTRACT

A wound paperboard core for inorganic material comprises a plurality of paperboard plies wound one upon another about an axis and adhered together with adhesive to form a tube. An outer paperboard ply is helically wound about the tube and secured thereto. All of the plies except for the outer paperboard ply are adhered together with substantially full-coverage adhesive as in conventional cores. However, the outer paperboard ply is arranged to be readily peelable from the tube so that it (along with the inorganic material thereon) can be removed from the tube. The tube can be recycled (e.g., repulped and made into recycled paperboard or the like). The outer paperboard ply and inorganic waste can be disposed of in a landfill, and even though an increased fee may apply, the total weight is greatly reduced such that the fee is substantially reduced relative to the fee for disposing of the entire core.

### CROSS-REFERENCE TO RELATED APPLICATION

The present application claims the benefit of the priority date of U.S. Provisional Patent Application Ser. No. 61/102,051 filed on Oct. 2, 2008, the entire disclosure of which is hereby incorporated herein by reference.

### BACKGROUND OF THE INVENTION

The invention relates to paperboard cores used for winding rolls of inorganic material such as glass fiber or carbon fiber.

Typically the initial turns of the inorganic material are firmly glued to the outer surface of the core to facilitate start-up of the winding process. This inorganic material cannot later be detached from the core. Thus, when the roll of inorganic material has been unwound in use, some amount of the inorganic material remains adhered to the core.

In many places, increasingly stringent regulations govern what types of materials can be sent to landfills. For example, in Europe, recent legislation regulates the disposing of mixed waste consisting of both organic and inorganic materials. In some cases, the user disposing of mixed waste must pay a substantially higher fee than that for solely organic waste; in other cases, the user may be prohibited altogether from sending the mixed waste to a landfill.

Thus, in the case of a used core having glass or carbon fiber remaining on it, higher fees or outright prohibition may be imposed on the user.

### BRIEF SUMMARY OF THE DISCLOSURE

The present development was made to address this growing problem. In accordance with the present disclosure, a wound paperboard core for inorganic material comprises a plurality of paperboard plies wound one upon another about an axis and adhered together with adhesive to form a tube. An outer paperboard ply is helically wound about the tube and secured thereto. All of the plies except for the outer paperboard ply are adhered together with substantially full-coverage adhesive as in conventional cores. However, the outer paperboard ply is arranged to be readily removable from the tube so that it (along with any inorganic material thereon) can be removed from the tube. The tube can be recycled (e.g., repulped and made into recycled paperboard or the like). The outer paperboard ply and inorganic waste can be disposed of in a landfill, and even though an increased fee may apply, the total volume and weight are greatly reduced such that the fee is substantially reduced relative to the fee for disposing of the entire core.

The outer paperboard ply can be affixed about the tube in various ways. In one embodiment, adhesive is used to affix the ply, but the adhesive is applied only in selected areas. For instance, the ply's edges can slightly overlap and the adhesive can be applied between the overlapping edges while the non-overlapping portions of the ply are substantially free of adhesive (although the non-overlapping portions can have intermittent adhesive spots to keep the ply from rotating relative to the underlying tube).

Alternatively, the outer paperboard ply can be affixed to the tube by winding the ply while it has a higher moisture content than the other plies, and the subsequent shrinkage of the outer paperboard ply causes it to tighten about the tube.

A combination of moisture and intermittent adhesive can also be used.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 is a perspective view of a winding core in accordance with one embodiment of the invention; and

FIG. 2 is a schematic depiction of an apparatus and process for making a winding core in accordance with an embodiment of the invention.

### DETAILED DESCRIPTION OF THE DRAWINGS

The present invention now will be described more fully hereinafter with reference to the accompanying drawings in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

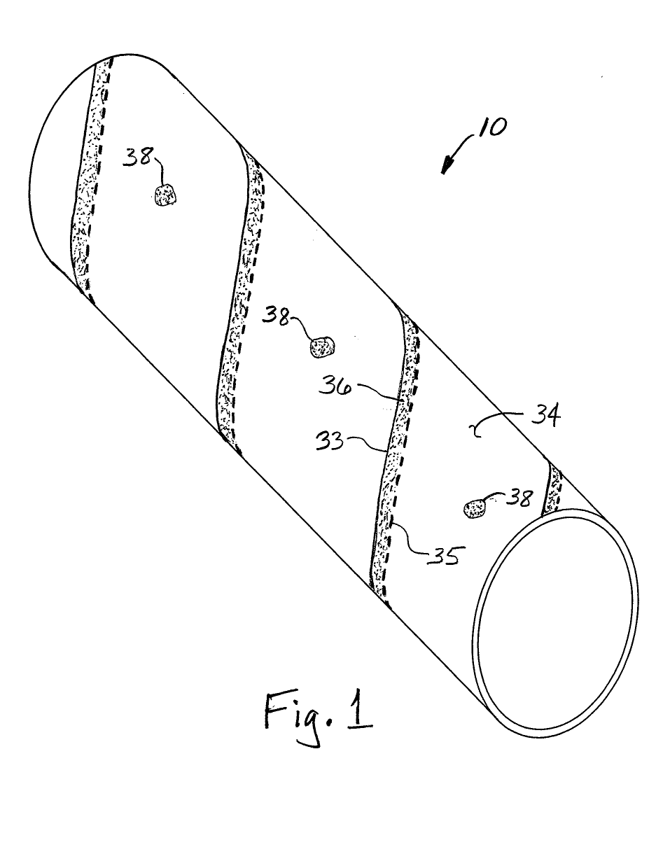

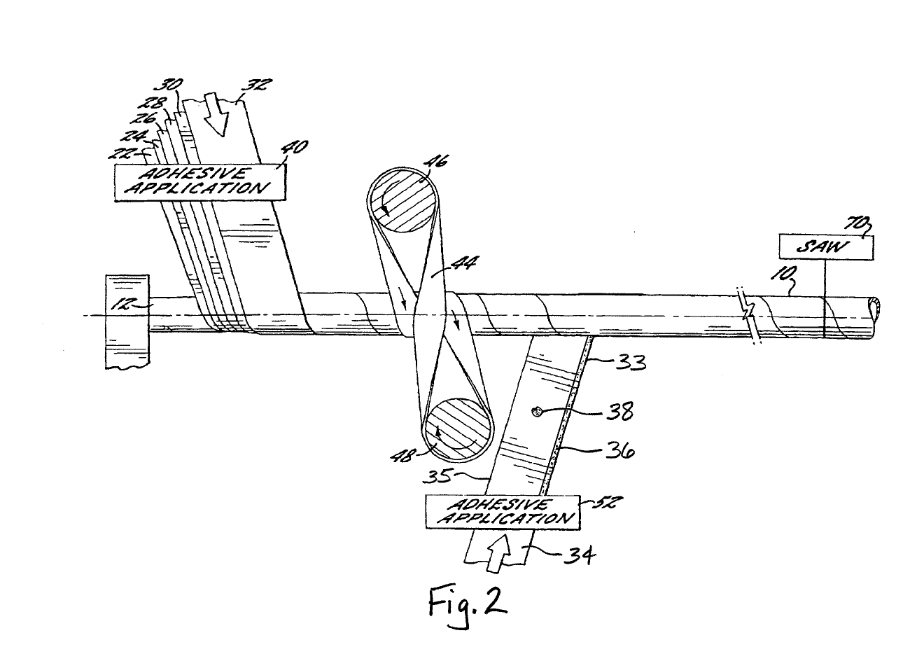

A winding core 10 in accordance with one embodiment of the invention is depicted in FIG. 1. An apparatus and process for making the winding core are shown in FIG. 2. The winding core 10 is a spirally or helically wound paperboard structure made up of a plurality of paperboard plies 22, 24, 26, 28, 30, 32, and 34. It will be understood that the illustrated embodiment is merely exemplary, and a winding core in accordance with the present invention can be made from any suitable number of plies depending on the needs of a particular application. The plies 22-34 are helically wound one upon another about a cylindrical mandrel 12. An adhesive applicator 40 of any suitable type applies adhesive to the plies 22-32 such that the adhesive covers substantially the entire surface of at least one side of each of these plies. The plies 22-32 thus form a tube on the mandrel 12. This tube is rotated in screw fashion along the mandrel by a winding belt 44 wrapped about a pair of winding drums 46, 48, as is conventional in spiral tube making.

An outer paperboard ply 34 is helically wrapped about the tube, preferably at a location downstream of the winding belt 44 as shown. The ply 34 is selected to have a width such that, based on the known diameter of the tube formed on the mandrel and the helical winding angle determined by the pitch of the winding belt 44, one longitudinal edge 33 of the ply overlaps the opposite longitudinal edge 35 by a certain amount. An adhesive applicator 52 applies adhesive to the outer paperboard ply 34 in only selected regions of the ply. In particular, the adhesive is applied to the inwardly facing side of the ply 34 (the side facing the mandrel) in a strip 36 along the longitudinal edge 33 of the ply 34. (Alternatively, the strip 36 can be applied to the outwardly facing side of the ply 34 along the opposite edge 35.) Optionally, in some embodiments of the invention, the adhesive applicator 52 (or a separate applicator) can apply a spot 38 of adhesive to the inwardly facing side of the ply 34 at spaced intervals along the length of the ply.

The adhesive strip 36 has a width that preferably does not exceed the amount by which the edges 33, 35 of the outer paperboard ply 34 overlap. This results in the ply 34 being adhered to itself at its overlapping edges, but being essentially unattached to the underlying paperboard tube formed by the inner plies 22-32. If it is desirable or necessary to attach the ply 34 to the underlying tube, discrete spaced spots 38 of adhesive can be employed, but such spots preferably are used as sparingly as possible so as not to interfere with the desired easy removability of the outer ply 34 from the tube.

The finished continuous winding core 10 on the mandrel 12 is cut into discrete lengths by a cutoff saw 70 and the cores are then allowed to dry for a period of time.

The winding core 10 can be made in various lengths, inside diameters, and wall thicknesses, and can include various numbers of paperboard plies.

In preferred embodiments of the invention, the adhesive strip 36 and any adhesive spots 38 employed for preventing rotation of the outer ply 34 relative to the underlying tube collectively occupy less than 25 percent of the total surface area of the ply 34. More preferably the adhesive occupies less than 20 percent of the total surface area of the ply, still more preferably less than 15 percent, and even more preferably less than 10 percent.

When the spaced adhesive spots 38 are included, it is preferred that they collectively occupy less than 20 percent of the total surface area of the ply 34. More preferably the adhesive spots 38 occupy less than 15 percent of the total surface area of the ply, still more preferably less than 10 percent, and even more preferably less than 5 percent. Additionally or alternatively, the spots 38 should be spaced apart along the length of the outer ply 34 so that the total number of such spots 38 in a given winding core 10 does not exceed 20, more preferably does not exceed 15, still more preferably does not exceed 10, and even more preferably does not exceed 5. For example, in the exemplary core 10 shown in FIG. 1 there are three adhesive spots 38.

Other embodiments of the invention are also possible. For example, in some embodiments, the non-overlapping portions of the outer paperboard ply 34 (i.e., the portions of the ply that make contact with the underlying paperboard tube) are completely free of adhesive. In this case, to prevent the outer ply from rotating relative to the tube during winding and unwinding operations, the outer paperboard ply has a roughened surface against the tube. The roughened surface has a higher friction and thus helps to prevent the outer paperboard ply from rotating relative to the tube during winding and unwinding of inorganic material about the winding core.

Another technique for securing the outer ply 34 about the tube and preventing its rotation during winding and unwinding operations is to “dry-shrink” the outer ply on the tube. That is, the outer paperboard ply 34 is wound about the tube at a moisture content higher than that of the paperboard plies 22-32 making up the tube, whereupon the outer paperboard ply subsequently loses moisture by evaporation and therefore shrinks about the tube.

A combination of adhesive spots and dry-shrinking can also be used.

In use, the winding core 10 is used for winding a roll of inorganic material, such as glass fiber matt. Typically the first winding of the matt is glued to the winding core to secure the end of the matt and facilitate start-up of the winding operation. This gluing of the matt makes it impossible in most cases to completely remove the glass fiber matt from the winding core after the roll is completely unwound. In accordance with the invention, the operator can slit the outer ply 34 longitudinally along the full length of the core and can remove the outer ply along with any glass fiber material remaining attached to it. The underlying paperboard tube can then be recycled (e.g., repulped and made into other paper products), while the outer ply can be disposed of (e.g., in a landfill). With the winding core of the invention, the total volume and mass of material being disposed of in the landfill are greatly reduced in comparison with disposing of the entire winding core.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A winding core for winding inorganic materials, comprising:
a plurality of paperboard plies helically wound one upon another about an axis and adhered together to form a tube; and
an outer paperboard ply helically wound about the tube such that one longitudinal edge of the outer paperboard ply overlaps an opposite longitudinal edge thereof, the outer paperboard ply being secured about the tube by adhesive disposed between the overlapping longitudinal edges, while non-overlapping portions of the outer paperboard ply are substantially free of adhesive, the outer paperboard ply being removable from the tube because of the substantial absence of adhesive between the outer paperboard ply and the tube.

2. The winding core of claim 1, wherein the adhesive occupies less than 25 percent of the surface area of the outer paperboard ply.

3. The winding core of claim 1, wherein the adhesive occupies less than 20 percent of the surface area of the outer paperboard ply.

4. The winding core of claim 1, wherein the adhesive occupies less than 15 percent of the surface area of the outer paperboard ply.

5. The winding core of claim 1, wherein the adhesive occupies less than 10 percent of the surface area of the outer paperboard ply.

6. The winding core of claim 1, wherein the non-overlapping portions of the outer paperboard ply are adhered to the tube by spaced discrete spots of adhesive in order to prevent the outer paperboard ply from rotating relative to the tube during winding and unwinding of inorganic material about the winding core.

7. The winding core of claim 6, wherein the spots of adhesive collectively occupy less than 20 percent of the total surface area of the outer paperboard ply.

8. The winding core of claim 6, wherein the spots of adhesive collectively occupy less than 15 percent of the total surface area of the outer paperboard ply.

9. The winding core of claim 6, wherein the spots of adhesive collectively occupy less than 10 percent of the total surface area of the outer paperboard ply.

10. The winding core of claim 6, wherein the spots of adhesive collectively occupy less than 5 percent of the total surface area of the outer paperboard ply.

11. The winding core of claim 6, wherein the total number of spots of adhesive does not exceed 20.

12. The winding core of claim 6, wherein the total number of spots of adhesive does not exceed 15.

13. The winding core of claim 6, wherein the total number of spots of adhesive does not exceed 10.

14. The winding core of claim 6, wherein the total number of spots of adhesive does not exceed 5.

15. The winding core of claim 1, wherein the non-overlapping portions of the outer paperboard ply are completely free of adhesive, and wherein the outer paperboard ply has a roughened surface against the tube, the roughened surface helping to prevent the outer paperboard ply from rotating relative to the tube during winding and unwinding of inorganic material about the winding core.

16. The winding core of claim 1, wherein the non-overlapping portions of the outer paperboard ply are completely free of adhesive, and wherein the outer paperboard ply is shrunk about the tube by being wound about the tube at a moisture content higher than that of the paperboard plies making up the tube, whereupon the outer paperboard ply subsequently loses moisture by evaporation and therefore shrinks about the tube.
